(19) United States
(12) Patent Application Publication
(10) Pub. No.: US 2024/0210567 A1
(43) Pub. Date: Jun. 27, 2024

(54) REDUCED SIZE FOR GNSS CORRECTION POINTS

(71) Applicant: Nokia Solutions and Networks Oy, Espoo (FI)

(72) Inventor: Robert SAXON, Naperville, IL (US)

(21) Appl. No.: 18/541,790

(22) Filed: Dec. 15, 2023

(30) Foreign Application Priority Data
Dec. 21, 2022 (FI) 20226136

(51) Int. Cl. G01S 19/23

(52) U.S. Cl. CPC G01S 19/23

(57) ABSTRACT

A method for providing correction information includes receiving, by a processor, grid data from a correction service, repackaging the grid data, and transmitting the repackaged grid data to a user equipment.

### BACKGROUND

A user equipment (UE) may determine a location of the user equipment using a global navigation satellite system (GNSS), e.g., global positioning system (GPS). For more precise position determination, the UE may use correction information. The correction information used by the UE may be provided by a correction service.

### SUMMARY

The scope of protection sought for various example embodiments of the disclosure is set out by the independent claims. The example embodiments and/or features, if any, described in this specification that do not fall under the scope of the independent claims are to be interpreted as examples useful for understanding various embodiments.

One or more example embodiments provide a method and apparatus for providing correction information.

At least one example embodiment provides a method for providing correction information, the method including receiving, by a processor, grid data from a correction service, repackaging the grid data, and transmitting the repackaged grid data to a user equipment.

The repackaging the grid information includes reformatting the grid for one gird point.

The method further includes searching the grid data for a nearest point. The repackaging the grid data includes repackaging the grid data in response to locating the nearest point.

The grid data includes a plurality of grid points. The searching the grid data includes generating respective locations for the plurality of grid points based on reference point information and searching for the nearest point based on the respective locations of the plurality of grid points.

The method further includes determining whether the grid data has a N×M shape. The searching the grid data includes searching the grid data in response to determining that the grid data has the N×M shape.

The transmitting the repackaged grid data includes transmitting the repackaged grid data via a system information block.

The method further includes determining visible satellites based on the nearest point and removing information corresponding with satellites not included in the visible satellites from other data received from the correction service.

At least one example embodiment provides a device for providing correction information, the device including at least one memory storing computer program code and at least one processor configured to execute the computer program code and cause the device to receive grid data from a correction service, repackage the grid data, and transmit the repackaged grid data for use by a user equipment.

The processor is further configured to cause the device to reformat the grid to one grid point.

The processor is further configured to cause the device to search the grid data for a nearest point and repackage the grid data in response to locating the nearest point.

The grid data includes a plurality of grid points. The processor is further configured to cause the device to generate respective locations for the plurality of grid points based on reference point information and search for the nearest point based on the respective locations of the plurality of grid points.

The processor is further configured to cause the device to determine whether the grid data has a N×M shape and search the grid data in response to determining that the grid data has the N×M shape.

The processor is further configured to cause the device to transmit the repackaged grid data to a base station. The base station is configured to transmit the repackaged grid data to the user equipment via a system information block.

At least one example embodiment provides a non-transitory computer-readable storage medium storing computer-readable instructions that, when executed, cause one or more processors to cause a communication device to perform a method for providing correction information. The method includes receiving, by a processor, grid data from a correction service, repackaging the grid data, and transmitting the repackaged grid data for use by a user equipment.

The repackaging the grid data includes reformatting the grid for one grid point.

The method further includes searching the grid data for a nearest point. The repackaging the grid data includes repackaging the grid data in response to locating the nearest point.

The grid data includes a plurality of grid points and the searching the grid data includes generating respective locations for the plurality of grid points based on reference point information and searching for the nearest point based on the respective locations of the plurality of grid points.

The method further includes determining whether the grid data has a N×M shape. The searching the grid data includes searching the grid data in response to determining that the grid data has the N×M shape.

The transmitting the repackaged grid data includes transmitting the repackaged grid data to a base station. The base station is configured to transmit the repackaged grid data to the user equipment via a system information block.

At least one example embodiment provides a device for providing correction information, the device including a means for receiving grid data from a correction service, a means for repackaging the grid data, and a means for transmitting the repackaged grid data to a user equipment.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of this disclosure.

FIG. 1 illustrates a simplified diagram of a portion of a 3rd Generation Partnership Project (3GPP) New Radio (NR) access deployment for explaining example embodiments.

FIG. 2A is a block diagram illustrating an example embodiment of a gNB according to example embodiments.

FIG. 2B is a block diagram illustrating an example embodiment of a LMS according to example embodiments.

FIG. 3 is a block diagram illustrating an example embodiment of a UE according to example embodiments.

FIG. 4 is a flowchart illustrating a method according to example embodiments.

FIG. 5A is a flowchart illustrating a method according to example embodiments.

FIG. 5B is a flowchart illustrating a method according to example embodiments.

FIG. 6 is an example of a N×M grid according to example embodiments.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

Various example embodiments will now be described more fully with reference to the accompanying drawings in which some example embodiments are shown.

Detailed illustrative embodiments are disclosed herein. However, specific structural and functional details disclosed herein are merely representative for purposes of describing example embodiments. The example embodiments may, however, be embodied in many alternate forms and should not be construed as limited to only the embodiments set forth herein.

It should be understood that there is no intent to limit example embodiments to the particular forms disclosed. On the contrary, example embodiments are to cover all modifications, equivalents, and alternatives falling within the scope of this disclosure. Like numbers refer to like elements throughout the description of the figures.

While one or more example embodiments may be described from the perspective of radio access network (RAN) or radio network elements (e.g., a gNB), user equipment (UE), or the like, it should be understood that one or more example embodiments discussed herein may be performed by the one or more processors (or processing circuitry) at the applicable device. For example, according to one or more example embodiments, at least one memory may include or store computer program code, and the at least one memory and the computer program code may be configured to, with at least one processor, cause a radio network element (or user equipment) to perform the operations discussed herein.

As discussed herein the terminology “one or more” and “at least one” may be used interchangeably.

As discussed herein, a gNB may also be referred to as a base station, access point, enhanced NodeB (eNodeB), or more generally, a radio access network element, radio network element, or network node. A gNB may be implemented by a split architecture. In a split architecture, the gNB functionalities are split between a distributed unit (DU) and a central unit (CU). A split architecture may further include a relay node (e.g., integrated access and backhaul (IAB)). Some gNB functionalities may be performed by a DU portion of the IAB node. For example, the DU portion of the IAB node may facilitate (child) radio links from the DU portion to a user equipment and/or to another IAB node.

A UE may also be referred to herein as a mobile station, and may include a mobile phone, a cell phone, a smartphone, a handset, a personal digital assistant (PDA), a tablet, a laptop computer, a phablet, or the like. The UE may be implemented as a mobile termination (MT) part of the IAB node. The MT part may facilitate a parent link (e.g., backhaul link) to the serving DU.

It will be appreciated that a number of example embodiments may be used in combination.

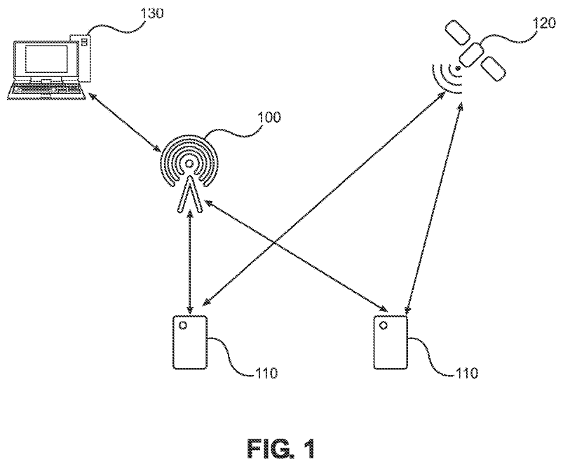

FIG. 1 illustrates a simplified diagram of a portion of a 3rd Generation Partnership Project (3GPP) New Radio (NR) access deployment for explaining example embodiments.

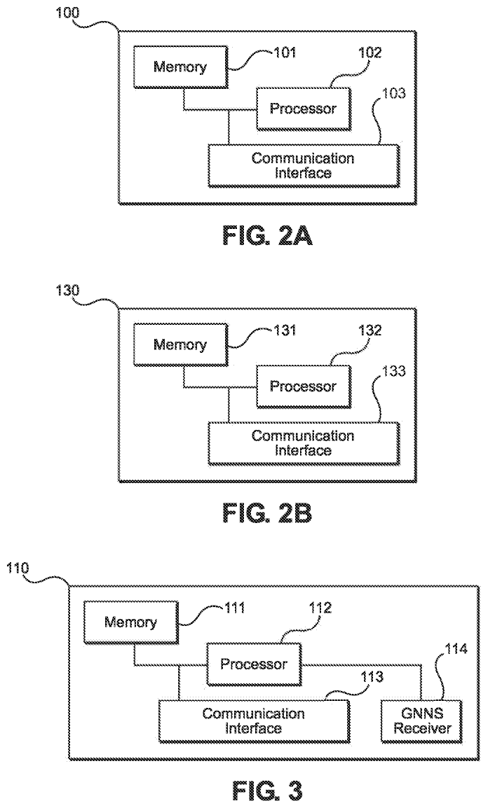

The portion of the 3GPP NR access deployment shown in FIG. 1 illustrates an example of two user equipments (UEs) 110 connected to a gNB 100, according to example embodiments. However, example embodiments are not limited thereto, and any number of UEs 110 may be connected to a gNB 100 at a given time. As shown in FIG. 2, the UEs 110 may receive global positioning information from a global navigation satellite system (GNSS) 120 and the gNB 100 may exchange information with a location management server (LMS) 130.

The LMS 130 may include, for example, a location management function (LMF). The gNB 100 and the LMS 130 are shown in FIG. 1 as separate devices. However, example embodiments are not limited thereto. For example, the LMS 130 may be included in and/or implemented by the gNB 100.

FIG. 2A is a block diagram illustrating an example embodiment of a gNB 100 according to example embodiments.

Referring to FIG. 2A, the gNB 100 may also be referred to as a base station, access point, enhanced NodeB (eNodeB), or more generally, a radio access network element, radio network element, or network node. The gNB 100 may include a memory 101, processing circuitry (such as at least one processor 102), and/or a communication interface 103. The memory 101 may include various special purpose program code including computer executable instructions which may cause the gNB 100 to perform the one or more of the methods of the example embodiments. The gNB 100 may be configured to perform the gNB functions in accordance with example embodiments. The communication interface 103 may include a wireless communication interface and/or a wired communication interface.

In at least one example embodiment, the processing circuitry may include at least one processor (and/or processor cores, distributed processors, networked processors, etc.), such as the at least one processor 102, which may be configured to control one or more elements of the gNB 100, and thereby cause the gNB 100 to perform various operations. The processing circuitry (e.g., the at least one processor 102, etc.) is configured to execute processes by retrieving program code (e.g., computer readable instructions) and data from the memory 101 to process them, thereby executing special purpose control and functions of the entire gNB 100. Once the special purpose program instructions are loaded into, (e.g., the at least one processor 102, etc.), the at least one processor 102 executes the special purpose program instructions, thereby transforming the at least one processor 102 into a special purpose processor.

In at least one example embodiment, the memory 101 may be a non-transitory computer-readable storage medium and may include a random access memory (RAM), a read only memory (ROM), and/or a permanent mass storage device such as a disk drive, or a solid state drive. Stored in the memory 101 is program code (i.e., computer readable instructions) related to operating the gNB 100.

FIG. 2B is a block diagram illustrating an example embodiment of a LMS according to example embodiments.

Referring to FIG. 2B, the LMS 130 may include a memory 131, processing circuitry (such as at least one processor 132), and/or a communication interface 133. The LMS 130 may be any one of, but not limited to, a mobile device, a smartphone, a tablet, a laptop computer, a desktop computer and/or the like. The LMS 130 may be configured to perform the LMS functions described in accordance with example embodiments.

Descriptions of the memory 131, the processor 132, and the communication interface 133 may be substantially similar to the memory 101, the processor 102, and the communication interface 103, respectively, and are therefore omitted.

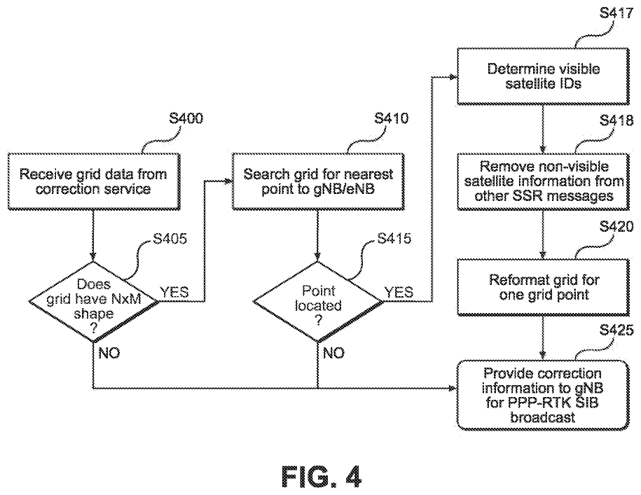

FIG. 3 is a block diagram illustrating an example embodiment of a UE according to example embodiments.

Referring to FIG. 3, the UE 110 may include a memory 111, processing circuitry (such as at least one processor 112), a communication interface 113, and/or a GNSS receiver 114. The UE 110 may be any one of, but not limited to, a mobile device, a smartphone, a tablet, a laptop computer, a desktop computer and/or the like. The UE 110 may be configured to perform the UE functions described in accordance with example embodiments.

Descriptions of the memory 111, the processor 112, and the communication interface 113 may be substantially similar to the memory 101, the processor 102, and the communication interface 103, respectively, and are therefore omitted. The GNSS receiver 114 may be an interface for communicating with and/or receiving a signal from a GNSS 120.

The UE 110 may determine a global position of the UE 110 based on a signal from the GNSS 120. The UE 110 uses standard methods to acquire the GNSS signal and to measure a received time stamp of such signals following well know techniques as defined by the constellation ICD (Interface Control Document).

The ICD defines how the UE 110 may interpret information broadcast from each GNSS 120 satellite. In some cases, the UE 110 is provided the GNSS broadcast information through the mobile network to reduce a time-to-first fix.

When the UE 110 has performed calculations defined by the constellation ICD the UE 110 is then able to estimate the time of day when the GNSS 120 satellite sent its signal received by the UE 110. Since the UE 110 has both send and receive time stamps it can calculate the time of flight (or time difference). The time difference and the satellite location are then used to calculate a pseudo range.

The pseudo range may include errors due to inaccuracies of the UE 110 internal clock. During the calculation of the location by the UE 110, the pseudo range from multiple GNSS 120 satellites (e.g., 4 or more) is resolved simultaneously to a solution that provides the location estimate (X, Y, Z and UE Time Correction).

This procedure allows the UE 110 to determine its own location. In some cases, the UE 110 may send raw GNSS measurements back to the mobile (operators) network (e.g., to the LMS 130 and/or the gNB 100) where some location service performs the calculation on behalf of the UE 110.

In all cases the UE 110 position may not be precise. Precise location methods may be used to improve on existing accuracy.

Typically, in good conditions such as open sky, the UE 110 is able to calculate a location with an accuracy of a few meters. The use of precise location methods employing correction data allows the UE 110 to resolve additional error sources and generate a location with an accuracy with a range of centimeters (e.g., 5 to 50 centimeters).

In order to more accurately calculate the global position, a UE 110 may use precise location methods to correct a calculated pseudo range for ionosphere errors. For example, a UE 110 may use precise location methods such as precise point positioning (PPP), real-rime kinematic positioning (RTK), and/or PPP-RTK to correct the calculated pseudo range for ionosphere errors.

The RTK method requires a two-way communication between the UE 110 and a correction service. For example, the UE 110 provides its location to the correction service and then the correction service provides specific information (e.g., Observation Space Representation) for that UE 110.

The PPP method does not require any location information to be shared to the correction service from the UE 110. However, the PPP method has the downside of long delay before a precise location is achieved.

The PPP-RTK method reduces the delay of the PPP method, while not requiring location information to be shared from the UE 110. A message provided to the UE 110 to perform the correction according to PPP-RTK may include correction points. The correction points are defined by a matrix to allow the UE 110 to calculate an error (e.g. ionosphere errors) to be removed.

RTK requires that the UE 110 receive correction information with respect to an RTK reference site. PPP or PPP-RTK only needs correction information with respect to the GNSS 120 satellite. This means PPP and PPP-RTK are global in nature and do not require direct reference state support.

According to example embodiments, the gNB 100 may broadcast correction information (e.g., state space representation (SSR)) to the UEs 110 for improving a location determination according to PPP-RTK. For example, the gNB 100 may broadcast the correction information to the UEs 110 via a system information block (SIB).

The SIB is a fundamental part of the radio interface. There are dedicated channels in the radio spectrum to allow the gNB 100 (or an eNB) the means to advertise information needed by the UE 110 for accessing the mobile network. SIB has been part of LTE/NR from initial design. Starting with 3GPP release 16, new SIB messages were added for use with RTK/PPP-RTK positioning.

With addition of a PPP-RTK SIB message to the SIB broadcast, the UE 110 may be able to receive correction data without need to connect to a specific service. Since PPP-RTK only uses SSR information, PPP-RTK may allow for broadcast scenarios without the need for two-way communication.

The gNB 100 may include a scheduler that manages SIB message content changes. The frequency of such change depends on the message type. SSR SIB messages may require a frequency update between 2 to 10 seconds. Actual rates may vary depending on the SSR service provided.

The LMS 130 may receive the correction information (e.g., SSR) from a precise location service.

The correction information may be large for use in broadcast service. For example, the correction information may include grid information, satellite orbit correction information, satellite clock correction information, satellite code/phase bias correction information, ionospheric delay correction information and/or tropospheric delay correction information.

A grid included in the grid information may be in a N×M format. For example, the grid information may be an 8×8 grid. However, example embodiments are not limited thereto, and the grid information may include grids of any N×M format where N and M are integers greater than 0.

Note that one grid point means one point for all visible satellites. Thus, this one point may have, for example, 8 to 12 satellites with additional structure.

The grid information may cover a very large space as compared to a serving area served by the gNB 100. For example, the entire US (e.g., the lower 48 states) may be defined with 6 grid maps provided by a precise location service. The closest grid point for correction data may be 50,000 to 200,000 meters away from a gNB 100.

Normal UE access to a gNB is under 2,000 meters for 95% of attempts and likely under 7,000 meters for 99% of attempts. Therefore, a UE 110 receiving correction information from a gNB 100 may only find one grid point, of the N×M grid, relevant for calculating a precise location of the UE 110.

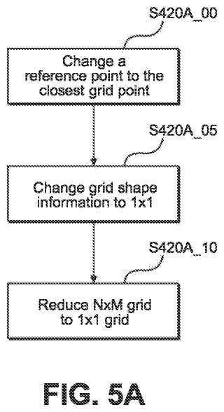

FIG. 4 is a flowchart illustrating a method according to example embodiments.

It is understood that the processor 132 executing program code cause the LMS 130 to perform the method of FIG. 4.

Referring to FIG. 4, at step S400 the LMS 130 may receive grid information. For example, the grid information may be included in correction information. For example, the LMS 130 may receive the correction information from a correction service. The correction information may include, for example, grid information, satellite orbit correction information, satellite clock correction information, satellite code/phase bias correction information, ionospheric delay correction information and/or tropospheric delay correction information.

The LMS 130 may extract the grid information from the correction information.

At step S405, the LMS 130 may determine whether a grid included in the grid information has a N×M shape. For example, the LMS 130 may check whether a number of steps corresponding to longitude (N) and/or latitude (M) in a correction points message included with the correction information are non-zero.

The 3GPP specification for location services defines PPP-RTK formations. One such format is a matrix. Another format is an array or list of positions. Since the 3GPP specification defines the grid as N×M shape it may be possible for a service in the mobile network to reshape the grid to a X×Y shape where X and Y are integers greater than 0. For example a 1×1 shape or a 2×2 shape.

If the LMS 130 determines that the grid does not have a N×M shape (NO at S405), then the LMS 130 proceeds to step S425.

At step S425, the LMS 130 transmits the correction information to the gNB 100 for transmission to the UEs 110. For example, the correction information transmitted to the gNB may include the grid information, satellite orbit correction information, satellite clock correction information, satellite code/phase bias correction information, ionospheric delay correction information and/or tropospheric delay correction information

For example the gNB 100 may broadcast the correction information to the UEs 110 via a SIB. However, example embodiments are not limited thereto, and the gNB 100 may transmit the correction information to the UEs 110 via any known transmission method.

The UEs 110 may use the correction information to perform location correction according to PPP-RTK. However, example embodiments are not limited thereto and the UEs 110 may use the grid information to perform location correction according to any known method.

The gNB 100 may transmit the correction information to the UEs 110 in a broadcast manner. For example, the gNB 100 may broadcast the grid to the UEs 110 via SIB.

Returning to step S405, if the LMS 130 determines that the grid has an N×M shape (YES at step S405), then the LMS 130 proceeds to step S410.

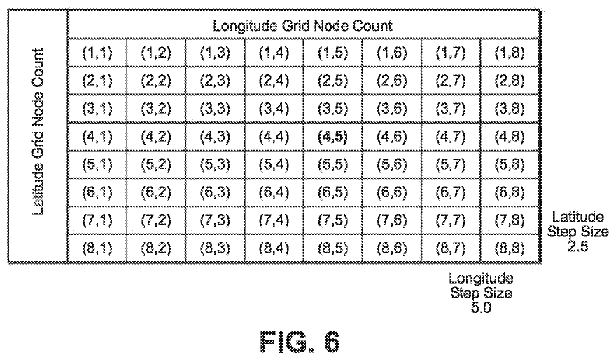

At step S410, the LMS 130 searches the points on the grid for a nearest point to the gNB 100. FIG. 6 is an example of a N×M grid according to example embodiments.

Referring to FIG. 6, an 8×8 grid is shown. However, example embodiments are not limited thereto and any N×M grid may be used.

Each grid point of the N×M grid may include a list of all visible satellites with the correction data defined by the SSR/3GPP specification. For example, the Ionospheric corrections are modeled as slant total electron content (STEC). STEC is typically modelled as a polynomial equation for each satellite but without any geographic dependency. The variance to STEC related to geographic area is then resolved as “residuals” specific to some geographic area. Each grid point for each satellite may include a value for the slant delay residual part needed for overall STEC correction. Such information is used by the UE 110 to correct for Ionospheric delay. The ionospheric delay impacts accuracy of the pseudo range measured by the UE 110.

The STEC correction information in the grid represents the residual part of the STEC polynomial to be provided over a geographic area. The UE 110 may use the grid to locate the point best suited for the position calculation. The grid may also include optional Tropospheric Delay Corrections. The grid overall has location specific corrections needed for the UE 110.

For example, each point of the N×M points of the grid may correspond with a geographic location. For example, the grid shown in FIG. 6 includes a latitude grid spacing of 2.5 degrees and a longitude grid spacing of 5.0 degrees.

The grid information may include grid data (e.g., the grid), a grid definition, and/or reference point information. The grid definition may include the grid size, spacing of the grid and reference point information. However, the grid definition may not include any specific location information. The reference point information may define the geographic location for grid point (1,1).

The grid may be defined as moving from west to cast and north to south. The most northwest grid point is (1,1) and the most southeast grid point is (N,M). To understand the location of a given grid point the (Row, Column) position is mapped to a location based on the reference point and the grid step size as defined by the standards.

For example, the reference point information may be provided as 47.5 degrees latitude north and 100.0 degrees longitude west. Thus, the grid point (1,1) may correspond with 47.5 degrees latitude north and 100.0 degrees longitude west.

The LMS 130 may have access to information such as a base site almanac (BSA). The LMS 130 may determine a geographic location of the gNB 100 based on the BSA. For example, the LMS 130 may search the BSA for a gNB identifier corresponding with the gNB 100. Such identify is needed when sending SIB information to the gNB.

The LMS 130 may determine which point, of the N×M points, is nearest to the geographic location of the gNB 100 based on the reference point information.

The LMS 130 may determine a geographic location of each, or one or more, of the grid points based on the reference point information.

For example, the LMS 130 may traverse the grid beginning at position (1,1), which corresponds with a known geographic location based on the reference point. The LMS 130 may traverse the grid by moving right for east and down for south until it finds the best match to the gNB. Each step on the grid may correspond with a step size included in the grid definition. For example, the grid definition may include a longitude step size and a latitude step size. For example, as shown in FIG. 6, the latitude step size may be 2.5 and/or the longitude step size may be 5.0. However, example embodiments are not limited thereto.

For example, the LMS 130 may determine the point (4,5) has a location of 40.0 degrees latitude north and 80.0 degrees longitude west.

Alternatively, the LMS 130 may traverse the grid to generate the locations for each, or one or more, of the grid points. Once all grid points are known, the LMS 130 may search for a grid point closest to the gNB 100.

Returning to FIG. 4, at step S415, the LMS 130 determines whether a nearest grid point is found (e.g., located). If the LMS 130 is unable to locate a nearest grid point to the gNB 100 (NO at step S415), then the LMS 130 proceeds to step S425.

If the LMS 130 determines that a nearest grid point to the gNB 100 is found (YES at S415), then the LMS 130 proceeds to step S417.

At step S417, the LMS 130 may determine visible satellite IDs corresponding with visible satellites based on the determined nearest grid point to the gNB 100.

Each grid point includes satellite IDs of the visible GNSS 120 satellites from the geographic location corresponding to the respective grid point. The LMS 130 may determine the visible satellite IDs according to the satellite IDs included in the grid data corresponding with the determined nearest grid point to the gNB 100.

At step S418, the LMS 130 may remove non-visible satellite information from other SSR messages included in the correction information.

Each SSR message that has satellite related information includes a satellite ID. Such SSR messages, included in the correction information, may include satellite orbit correction information, satellite clock correction information, satellite code/phase bias correction information, ionospheric delay correction information and/or tropospheric delay correction information. The satellite IDs included in each SSR message correspond with the satellite IDs included in the grid data.

The LMS 130 may remove the non-visible satellite information from the other SSR messages includes in the correction information by removing (e.g., deleting) satellite information corresponding with any satellite IDs not corresponding with the determined visible satellite IDs. The LMS 130 may remove the satellite information according to standard methods for data manipulation (e.g., copy original SSR message to new SSR message and skip satellite ID 1 during the copy action).

At step S420, the LMS 130 reformats the grid information. For example, the LMS 130 may reformat the N×M grid to a X×Y grid. For example, a 1×1 grid.

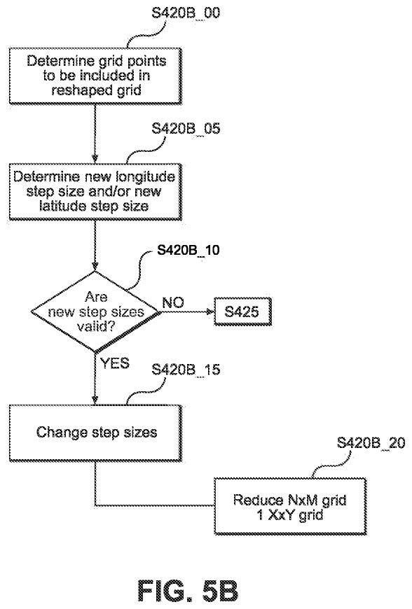

Reformatting the grid may also be referred to as repackaging. Methods for reformatting the grid according to example embodiments will be described in more detail later with regard to FIGS. 5A-5B.

Therefore, according to example embodiments, a size of grid information transmitted to the UEs 110 may be reduced. The grid information may therefore be more easily included in a SIB and/or the grid information may be transmitted more quickly and/or efficiently.

FIG. 5A is a flowchart illustrating a method according to example embodiments.

It is understood that the processor 132 executing program code cause the LMS 130 to perform the method of FIG. 5A.

Referring to FIG. 5A, at step S420A_00, the LMS 130 changes the reference point information to the grid point determined to be the closest grid point to the gNB 100.

At step S420A_05, the LMS 130 changes grid shape information included in the grid definition to 1×1.

At step S420A_05, the LMS 130 changes the grid data from N×M to 1×1. For example, the LMS 130 may delete information included in the grid data not corresponding to the grid point determined to be closest to the gNB 100. The LMS 130 may delete the data not corresponding to the grid point determined to be closes to the gNB 100 by any known method. This may effectively reduce the N×M grid to a single grid point. For example, the LMS 130 may reduce the N×M grid to a 1×1 grid including only the grid point determined to be closest to the gNB 100. An example of pseudocode for reducing the N×M grid to a 1×1 grid (e.g., one grid point) is shown below.

GNSS-SsR-ArrayOfCorrectionPoints-r16 ::=SEQUENCE {

| | |
|---|---|
| referencePointLatitude-r16 | INTEGER (−16384..16383), |
| referencePointLongitude-r16 | INTEGER (−32768..32767), |
| numberOfStepsLatitude-r16 | INTEGER (0..63), |
| numberOfStepsLongitude-r16 | INTEGER (0..63), |
| stepOfLatitude-r16 | INTEGER (1..511), |
| stepOfLongitude-r16 | INTEGER (1..1023), |
| bitmaskOfGrids-r16 | BIT STRING (SIZE (64)) |
| . . . | |
| } | |

An example of code representing grid data including one grid point is shown below.

STEC-ResidualSatList-r16 ::= SEQUENCE (SIZE (1. .64)) OF STEC-ResidualSatElement-r16
STEC-ResidualSatElement-r16 ::= SEQUENCE {

| | |
|---|---|
| sVID-r16 | S-ID, |
| stec ResidualCorrection-r16 | CHOICE { |
| b7-r16 | INTEGER (−64..63), |
| b16-r16 | INTEGER (−32768..32767) |

```
  },
  . . .
}
```

FIG. 5B is a flowchart illustrating a method according to example embodiments.

It is understood that the processor 132 executing program code cause the LMS 130 to perform the method of FIG. 5B.

In some cases, the SSR PPP-RTK service provider may require the original reference point be made available to the UE 110. As required by standards, the reference point defines the location of the first point in the grid. The grid has no direct location information. The grid shape allows for UE 110 to determine the location of each grid point by following the standards.

The first point (1,1) is defined as the reference point There are some cases when the original reference point is needed by the UE 110 for the polynomial part of the STEC correction. The polynomial part has up to 4 polynomial coefficients. 3 of the 4 coefficients require the reference point information during the correction calculation. If the coefficients cannot be remapped to a single grid point then the 2×2 grid shape may be sufficient and/or required to allow the original reference point to be provided.

The LMS 130 is informed by the SSR PPP-RTK service provided during SLA establishment whether the coefficients can be remapped. If allowed through the SLA the LMS 130 may remap the coefficients (e.g., reshape the grid to the 1×1 grid). If the LMS 130 is not allowed to remap the coefficients, the LMS 130 may reshape the grid to a X×Y grid including the original reference point.

Referring to FIG. 5B, at S420B_00, the LMS 130 may determine grid points to be included in a reshaped grid.

For example, the LMS 130 may determine the first grid point (e.g., (1,1)), the grid point determined to be closest to the gNB 100 (e.g., (R,C)), a point (1,C) on the first row that matches the same column as the grid point determined to be closest to the gNB 100, and/or a point (R,1) on the Rth row that matches the same row as the grid point determined to be closest to the gNB 100.

For example, referring to FIG. 6, if the grid point determined to be the closest to the gNB 100 is point (4,5), then the LMS 130 may determine the points (1,1), (4,5) (1,5), (4,1) and (4,5) to be included in the reshaped grid.

In some cases, the grid point determined to be closest to the gNB 100 may be at a first rank of a row or column of the grid. For example, the LMS 130 may determine the grid point closest to the gNB 100 to be grid point (1,4). In such cases, the LMS 130 may determine fewer than four grid points to be included in the reshaped grid.

For example, the LMS 130 may determine 3 grid points to be included in the reshaped grid when the grid point determined to be the closest to the gNB 100 is at a first rank of a row or a column of the grid that is not the reference point (e.g., a 1×2 reshaped grid in the case of grid point determined to be the closest to the gNB 100 being at a first rank of a row of the grid or a 2×1 reshaped grid in the case of the grid point determined to be the closest to the gNB 100 being at a first rank of a column of the grid). If the grid point determined to be the closest to the gNB 100 is the reference point, the LMS 130 may determine only the reference point to be included in the reshaped grid (e.g., a 1×1 reshaped grid).

Returning to FIG. 5B, at step S420B_05, the LMS 130 may determine a new longitude step size and/or a new latitude step size.

The LMS 130 may determine the new longitude step size and/or the new latitude step size, respectively, by taking the difference between the reference point and the longitude/latitude location of the grid point determined to be the closest to the gNB 100. This difference is between the starting point (1,1) and the grid point determined to be the closest to the gNB 100

At step S420B_10, the LMS 130 may determine whether the new longitude step size and/or the new latitude step size are valid step sizes. The step size has limits as defined by 3GPP SSR specifications. If either of the new longitude step size or the new latitude step size exceeds such standards (NO at step S 420B_10) then the LMS 130 proceeds to step S425.

If the LMS 130 determines that the new longitude step size and the new latitude step size are within the standards (YES at S420B_10) then the LMS 130 proceeds to step S420B_15.

At step S420B_15, the LMS 130 may change the longitude step size and/or the latitude step size included in the grid definition to the new longitude step size and/or the new latitude step size, respectively.

At step S420B_20, the LMS 130 may reduce (e.g., reshape) the grid to the X, Y reshaped grid. For example, the LMS 130 may delete information included in the grid data not corresponding to the grid points determined to be included in the reshaped grid. The LMS 130 may delete the data not corresponding to the grid points determined to be included in the reshaped grid by any known method.

For example, referring to FIG. 6, if the grid point determined to be the closest to the gNB 100 is point (4,5), then the LMS 130 may reshape the grid to include the points (1,1), (1,5), (4,1) and (4,5). This allows the UE 110 to locate the same point from the reshaped grid.

Although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of this disclosure. As used herein, the term “and/or,” includes any and all combinations of one or more of the associated listed items.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of example embodiments. However, it will be understood by one of ordinary skill in the art that example embodiments may be practiced without these specific details. For example, systems may be shown in block diagrams so as not to obscure the example embodiments in unnecessary detail. In other instances, well-known processes, structures and techniques may be shown without unnecessary detail in order to avoid obscuring example embodiments.

As discussed herein, illustrative embodiments will be described with reference to acts and symbolic representations of operations (e.g., in the form of flow charts, flow diagrams, data flow diagrams, structure diagrams, block diagrams, etc.) that may be implemented as program modules or functional processes include routines, programs, objects, components, data structures, etc., that perform particular tasks or implement particular abstract data types and may be implemented using existing hardware at, for example, existing network apparatuses, elements or entities including cloud-based data centers, computers, cloud-based servers, or the like. Such existing hardware may be processing or control circuitry such as, but not limited to, one or more processors, one or more Central Processing Units (CPUs), one or more controllers, one or more arithmetic logic units (ALUs), one or more digital signal processors (DSPs), one or more microcomputers, one or more field programmable gate arrays (FPGAs), one or more System-on-Chips (SoCs), one or more programmable logic units (PLUS), one or more microprocessors, one or more Application Specific Integrated Circuits (ASICs), or any other device or devices capable of responding to and executing instructions in a defined manner.

Although a flow chart may describe the operations as a sequential process, many of the operations may be performed in parallel, concurrently or simultaneously. In addition, the order of the operations may be re-arranged and/or some operations may be omitted. A process may be terminated when its operations are completed, but may also have additional steps not included in the figure. A process may correspond to a method, function, procedure, subroutine, subprogram, etc. When a process corresponds to a function, its termination may correspond to a return of the function to the calling function or the main function.

As disclosed herein, the term “storage medium,” “computer readable storage medium” or “non-transitory computer readable storage medium” may represent one or more devices for storing data, including read only memory (ROM), random access memory (RAM), magnetic RAM, core memory, magnetic disk storage mediums, optical storage mediums, flash memory devices and/or other tangible machine-readable mediums for storing information. The term “computer-readable medium” may include, but is not limited to, portable or fixed storage devices, optical storage devices, and various other mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks. For example, as mentioned above, according to one or more example embodiments, at least one memory may include or store computer program code, and the at least one memory and the computer program code may be configured to, with at least one processor, cause a network apparatus, network element or network device to perform the necessary tasks. Additionally, the processor, memory and example algorithms, encoded as computer program code, serve as means for providing or causing performance of operations discussed herein.

A code segment of computer program code may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable technique including memory sharing, message passing, token passing, network transmission, etc.

The terms “including” and/or “having,” as used herein, are defined as comprising (i.e., open language). The term “coupled,” as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

According to example embodiments, network apparatuses, elements or entities including cloud-based data centers, computers, cloud-based servers, or the like, may be (or include) hardware, firmware, hardware executing software or any combination thereof. Such hardware may include processing or control circuitry such as, but not limited to, one or more processors, one or more CPUs, one or more controllers, one or more ALUs, one or more DSPs, one or more microcomputers, one or more FPGAs, one or more SoCs, one or more PLUS, one or more microprocessors, one or more ASICs, or any other device or devices capable of responding to and executing instructions in a defined manner.

What is claimed is:

1. A method for providing correction information, the method comprising:
receiving, by a processor, grid data from a correction service;
repackaging the grid data; and
transmitting the repackaged grid data to a user equipment.

2. The method of claim 1, wherein the repackaging the grid data includes reformatting the grid for one grid point.

3. The method of claim 1, further comprising:
searching the grid data for a nearest point,
wherein the repackaging the grid data includes repackaging the grid data in response to locating the nearest point.

4. The method of claim 3, wherein the grid data includes a plurality of grid points, and wherein the searching the grid data includes
generating respective locations for the plurality of grid points based on reference point information, and
searching for the nearest point based on the respective locations of the plurality of grid points.

5. The method of claim 4, further comprising:
determining whether the grid data has a N×M shape,
wherein the searching the grid data includes searching the grid data in response to determining that the grid data has the N×M shape.

6. The method of claim 1, wherein the transmitting the repackaged grid data includes transmitting the repackaged grid data via a system information block.

7. The method of claim 3, further comprising:
determining visible satellites based on the nearest point; and
removing information corresponding with satellites not included in the visible satellites from other data received from the correction service.

8. A device for providing correction information, the device comprising:
at least one memory storing computer program code; and
at least one processor configured to execute the computer program code and cause the device to,
receive grid data from a correction service,
repackage the grid data, and
transmit the repackaged grid data for use by a user equipment.

9. The device of claim 8, wherein the at least one memory and the computer program code are further configured to, with the at least one processor, cause the device to reformat the grid to one grid point.

10. The device of claim 8, wherein the at least one memory and the computer program code are further configured to, with the at least one processor, cause the device to:
search the grid data for a nearest point; and
repackage the grid data in response to locating the nearest point.

11. The device of claim 10, wherein the grid data includes a plurality of grid points, and
the at least one memory and the computer program code are further configured to, with the at least one processor, cause the device to
generate respective locations for the plurality of grid points based on reference point information, and
search for the nearest point based on the respective locations of the plurality of grid points.

12. The device of claim 11, wherein the at least one memory and the computer program code are further configured to, with the at least one processor, cause the device to:
determine whether the grid data has a N×M shape; and
search the grid data in response to determining that the grid data has the N×M shape.

13. The device of claim 8, wherein the at least one memory and the computer program code are further configured to, with the at least one processor, cause the device to transmit the repackaged grid data to a base station,
wherein the base station is configured to transmit the repackaged grid data to the user equipment via a system information block.

14. A non-transitory computer-readable storage medium storing computer-readable instructions that, when executed, cause one or more processors to cause a communication device to
receive grid data from a correction service,
repackage the grid data, and
transmit the repackaged grid data for use by a user equipment.
